(19) United States
(12) Patent Application Publication
(10) Pub. No.: US 2025/0219685 A1
(43) Pub. Date: Jul. 3, 2025

(54) Efficient Unified Beamforming Techniques for Multi-Link Operations

(71) Applicant: Cisco Technology, Inc., San Jose, CA (US)

(72) Inventors: Indermeet Gandhi, San Jose, CA (US); Jerome Henry, Pittsboro, NC (US); Matthew Silverman, Shaker Heights, OH (US); Malcolm Smith, Richardson, TX (US)

(21) Appl. No.: 18/597,897

(22) Filed: Mar. 6, 2024

Related U.S. Application Data
(60) Provisional application No. 63/615,720, filed on Dec. 28, 2023.

(51) Int. Cl. H04B 7/0456

(52) U.S. Cl. CPC H04B 7/0456

(57) ABSTRACT

In various embodiments described herein, network devices, such as clients and access points (APs) can conduct an association or sounding process utilizing a unified beamforming matrix. As wireless network associations are increasingly utilizing multiple links, processes that are typically done for each link can become redundant. In response, embodiments described herein can unify, compress, or otherwise streamline beamforming operations across multiple links into one link. For example, beamforming over multiple links can traditionally require data to be exchanged on each link. The beamforming parameters can instead, in many embodiments, transmit beamforming data or matrices on a single link that comprises a unified beamforming matrix, which can reduce the amount of data that is transmitted, and reduce temporal decay by packaging and transmitting data together instead of transmitting over each and every link. This can improve overall network performance and increase transmission efficiency.

### CROSS-REFERENCE TO RELATED APPLICATION

This application claims the benefit of U.S. Provisional Patent Application No. 63/615,720, filed Dec. 28, 2023, which is incorporated by reference herein in its entirety.

The present disclosure relates to wireless networking. More particularly, the present disclosure relates to coordinating beamforming sounding across numerous bands of a multi-link operation.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, access points (APs), supporting multiple bands independently, create distinct links to serve Wi-Fi Stations are contemplated. However, to optimize spectrum utilization and enhance throughput performance, the IEEE 802.11be standard introduces the Multilink Operation (MLO). MLO enables the simultaneous transmission of data frames on multiple links, allowing for asynchronous channel access and improved power save capabilities. MLO facilitates frame transmission and retransmission on any link, regardless of the initial transmission link. MLO comes in various types, including Multilink Multiradio (MLMR) for devices with multiple radios and Multilink Single-Radio (MLSR) for those with a single radio. MLSR has limitations in band switching due to having only one radio, leading to static band switches. To address this, Enhanced Multilink Single-Radio (eMLSR) operation is introduced, allowing dynamic band switching for improved throughput and latency performance.

### SUMMARY OF THE DISCLOSURE

Systems and methods for coordinating beamforming sounding across numerous bands of a multi-link operation in accordance with embodiments of the disclosure are described herein. In some embodiments, a device includes a processor, at least one network interface controller configured to provide access to a network, and a memory communicatively coupled to the processor, wherein the memory includes a beamforming logic. The logic is configured to receive a null data packet (NDP), wherein the NDP is associated with two or more links, perform a downlink channel estimation on each of the two or more links, compute a beamforming matrix for each of the two or more links, and aggregate each beamforming matrix into a unified beamforming matrix.

In some embodiments, the beamforming logic is further configured to incorporate the unified beamforming matrix into a compressed beamforming feedback (CBF) frame.

In some embodiments, the beamforming logic is further configured to evaluate a signal-to-noise ratio (SNR) value for each of the two or more links.

In some embodiments, the beamforming logic is further configured to select a link with a highest SNR value.

In some embodiments, the beamforming logic is further configured to transmit the CBF frame over the selected link.

In some embodiments, the beamforming logic is further configured to transmit a dialog token associated with the unified beamforming matrix.

In some embodiments, the null data packet is associated with a multi-link beamforming process.

In some embodiments, the aggregation of each beamforming matrix is based on a matrix concatenation process.

In some embodiments, the aggregation of each beamforming matrix is based on a stacking process.

In some embodiments, the aggregation of each beamforming matrix is based on a differential CBF feedback mode.

In some embodiments, a device includes a processor, at least one network interface controller configured to provide access to a network, and a memory communicatively coupled to the processor, wherein the memory includes a beamforming logic. The logic is configured to transmit at least one null data packet, receive one or more compressed beamforming feedback (CBF) frames, extract a unified beamforming matrix from the one or more CBF frames, parse the unified beamforming matrix, and adjust one or more beamforming parameters based on the unified beamforming matrix.

In some embodiments, the beamforming logic is further configured to receive a dialog token associated with the one or more CBF frames.

In some embodiments, the beamforming logic is further configured to verify the received one or more CBF frames based on the received dialog token.

In some embodiments, the beamforming logic instead extracts a reference beamforming matrix and at least one differential reference matrix.

In some embodiments, the adjustment of the one or more beamforming parameters are based on the reference beamforming matrix and the at least one differential reference matrix.

In some embodiments, a method of managing a network includes receiving a null data packet (NDP), wherein the NDP is associated with two or more links, performing a downlink channel estimation on each of the two or more links, compute a reference beamforming matrix for a first link of the two or more links, and generate a differential reference matrix for each remaining link of the two or more links.

In some embodiments, the method further includes transmitting the reference beamforming matrix followed by the differential reference matrix.

In some embodiments, the method further includes transmitting each differential reference matrix.

In some embodiments, the reference beamforming matrix and each reference matrix is incorporated into a compressed beamforming feedback (CBF) frame.

In some embodiments, the transmitting of the reference beamforming matrix and each differential reference matrix is based on transmitting the CBF frame.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a networking logic may operate on a plurality of network devices, in accordance with various embodiments of the disclosure;

FIG. 4A is a conceptual illustration of a multi-radio, multi-band staggered sounding, in accordance with various embodiments of the disclosure;

FIG. 4B is a conceptual illustration of a single-radio, multi-band staggered sounding, in accordance with various embodiments of the disclosure;

FIG. 5 is a flowchart depicting a process for configuring one or more downlink beamforming parameters based on a unified beamforming matrix in accordance with various embodiments of the disclosure;

FIG. 6 is a flowchart depicting a process for generating a unified beamforming matrix for downlink connections in accordance with various embodiments of the disclosure;

FIG. 7 is a flowchart depicting a process for establishing a connection via a differential feedback mode in accordance with various embodiments of the disclosure;

FIG. 8 is a flowchart depicting a process for generating a unified beamforming matrix for uplink connections in accordance with various embodiments of the disclosure;

FIG. 9 is a flowchart depicting a process for configuring one or more uplink beamforming parameters based on a unified beamforming matrix in accordance with various embodiments of the disclosure; and

FIG. 10 is a conceptual block diagram of a device suitable for configuration with a beamforming logic and a networking logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to coordinate beamforming sounding across numerous bands of an MLO to an eMLSR device and signal for the device to send compressed feedback on one of the links for all links. In legacy Wi-Fi, beamforming sounding often involves exchanging null data packets (NDPs) and compressed beamforming (CBF) feedback frames between the AP and device. This can allow each device to estimate the channel matrix to compute transmit and receive beamforming vectors. However, in next generation Wi-Fi 8, wireless networks can utilize multi-link operation (MLO) which allows client stations (devices) to connect simultaneously to multiple access points (APs) or links for higher throughput and reliability. Existing sounding protocols may be designed and/or utilized for single link operations. In MLO, the device may be required to perform redundant sounding sequences on every link. This may consume excessive airtime that scales linearly with more links.

Moreover, the temporal decay between sounding sequences on different links can reduce accuracy when combining matrices for multi-link beamforming. While APs can coordinate to transmit NDPs simultaneously across links, the device may still provide redundant CBF feedback independently per link. Various embodiments described herein are configured to address the need for the device to unify or combine the beamforming matrices across concurrent links into one matrix. This unified matrix can then be efficiently fed back over the strongest single link. These embodiments can significantly reduce beamforming overhead in MLO while improving multi-link beamforming gain.

Beamforming in wireless networking is a technique used to enhance the performance and efficiency of wireless communication systems by directing signals towards specific devices rather than broadcasting uniformly in all directions. It often relies on multiple antennas to create focused transmission beams, effectively steering signals towards intended recipients. By adjusting the phase and amplitude of signals transmitted from each antenna, beamforming can shape the directionality of the radio waves, resulting in improved signal strength, reduced interference, and enhanced overall network capacity and coverage. This technology enables better utilization of available spectrum and can mitigate the effects of multipath propagation and environmental obstacles, leading to more reliable and higher throughput wireless connections, particularly in environments with high user density or challenging propagation conditions.

Multi-link operation in wireless networking refers to the capability of a device or a network to establish and manage multiple simultaneous connections with other devices or access points. This technology is particularly useful in scenarios where high throughput, redundancy, or load balancing are important considerations. By supporting multiple links concurrently, devices can distribute network traffic across different channels or paths, thereby optimizing performance and reliability. Multi-link operation can be implemented using various techniques such as channel bonding, where multiple channels are aggregated to increase data rates, or through the establishment of parallel connections to different access points or network nodes. This approach enhances overall network capacity, resilience against link failures, and improves the user experience by ensuring consistent and robust connectivity, especially in environments with high user density or diverse traffic demands.

Multi-link beamforming is an advanced technique in wireless networking that leverages the capabilities of beamforming and multi-link operation simultaneously to enhance the performance and efficiency of communication systems. This approach involves coordinating the transmission and reception of signals among multiple transmitters and receivers to achieve optimal spatial alignment and signal combining. By synchronizing the beamforming processes across multiple links, devices can exploit spatial diversity and multipath propagation to improve signal strength, mitigate interference, and increase overall throughput. Multi-link beamforming enables devices to dynamically adapt their beamforming patterns and transmission parameters based on the channel conditions and feedback from multiple receivers, resulting in more robust and reliable wireless connections. This technology is particularly beneficial in scenarios with dense deployments, high user density, or challenging propagation environments, where traditional beamforming or single-link operation may be insufficient to meet the demands for capacity and coverage.

Sounding involves the transmission of specially crafted packets, often referred to as probe frames or training frames, to gather information about the wireless channel conditions. These packets are typically sent from the transmitter (such as an access point or router) to the receiver (such as a client device), or vice versa, to estimate channel characteristics like signal strength, interference levels, and the presence of multipath propagation effects. The receiver then sends feedback to the transmitter, providing insights into the quality of the received signal, which helps the transmitter adapt its transmission parameters accordingly.

Sounding serves several critical purposes in wireless networking. Firstly, it enables devices to assess the channel quality dynamically and adjust their transmission parameters such as modulation schemes, coding rates, and beamforming patterns to maximize throughput and reliability. This adaptive behavior can be utilized for achieving optimal performance in changing radio environments with varying levels of interference and signal attenuation. Additionally, sounding facilitates the implementation of advanced techniques like spatial multiplexing and beamforming, where multiple data streams are transmitted simultaneously, or signals are directed towards specific receivers for improved spectral efficiency and coverage. Furthermore, sounding plays a vital role in coordinating transmissions among multiple devices in a network, particularly in scenarios with dense deployments or overlapping coverage areas. By exchanging sounding information, neighboring access points or devices can coordinate their transmission schedules to avoid interference and optimize resource allocation, enhancing overall network capacity and fairness.

Null data packets (NDPs) and compressed beamforming feedback frames (CBFs) are both components of the sounding process in wireless networks, particularly in advanced technologies like 802.11ax (Wi-Fi 6) and beyond. NDPs serve as specially crafted packets that are transmitted by the transmitter (e.g., an access point) to a receiver (e.g., a client device) for the purpose of channel sounding. These packets contain known symbols or sequences that allow the receiver to estimate the channel characteristics, such as signal strength, phase, and delay spread. This information is crucial for the receiver to provide accurate feedback to the transmitter regarding the quality of the received signal and the prevailing channel conditions.

On the other hand, compressed beamforming feedback frames (CBFs) are used by the receiver to convey this feedback to the transmitter in a concise and efficient manner. Instead of providing detailed channel state information (CSI) for each individual subcarrier or antenna element, CBFs summarize the key parameters using compression techniques such as quantization and encoding. This compression reduces the overhead associated with feedback transmission and allows for faster feedback cycles, enabling more responsive adaptation of transmission parameters by the transmitter. The relationship between NDPs and CBFs lies in their collaborative role within the sounding process: NDPs facilitate accurate channel estimation at the receiver, while CBFs enable efficient transmission of feedback information back to the transmitter. Together, these mechanisms enable dynamic adaptation of beamforming and transmission parameters, ultimately improving the performance, reliability, and spectral efficiency of wireless networks in diverse and challenging environments.

In wireless networking, a beamforming matrix represents a fundamental component of beamforming techniques, which are used to improve signal transmission and reception in wireless communication systems. The beamforming matrix is a mathematical construct that describes how the signals transmitted or received by an array of antennas are weighted and combined to form directional radiation patterns. Specifically, in transmit beamforming, the beamforming matrix determines the complex weights applied to each antenna's signal to steer the transmission beam in a desired direction towards the intended receiver. Similarly, in receive beamforming, the beamforming matrix specifies the weights applied to the signals received by each antenna to combine them coherently and enhance the received signal strength from a particular direction. The elements of the beamforming matrix are typically determined based on channel state information (CSI), which characterizes the wireless channel between the transmitter and receiver. By adjusting the beamforming matrix according to the channel conditions, beamforming techniques can improve signal quality, increase range, and mitigate interference, thereby enhancing the overall performance and reliability of wireless networks. Additionally, beamforming matrices play a crucial role in advanced technologies such as multiple-input multiple-output (MIMO) systems and massive MIMO, where multiple antennas are employed to further exploit spatial diversity and multipath propagation for improved spectral efficiency and capacity.

In wireless networking sounding, temporal decay refers to the phenomenon where the accuracy of channel state information (CSI) deteriorates over time due to changes in the wireless channel. The wireless channel is subject to various temporal variations caused by factors such as mobility of devices, movement of obstacles, environmental changes, and interference from other wireless devices. As a result, the characteristics of the channel, including signal strength, phase, and delay spread, may fluctuate over time.

Temporal decay is particularly relevant in scenarios with high mobility, such as in vehicular or pedestrian environments, where the wireless channel experiences rapid changes. As time progresses, the accuracy of CSI obtained during initial sounding or training may diminish, leading to suboptimal performance if not properly addressed. Therefore, mechanisms for tracking and compensating for temporal decay are often utilized null for maintaining reliable communication in dynamic wireless environments. To mitigate the effects of temporal decay, wireless systems may employ adaptive sounding techniques that periodically update CSI based on recent measurements. Additionally, advanced beamforming algorithms and feedback mechanisms can dynamically adjust transmission parameters in response to changing channel conditions, helping to optimize performance despite temporal variations.

In wireless networking, such as in the context of Wi-Fi Protected Access (WPA) and Wi-Fi Protected Access 2 (WPA2) protocols, a dialog token is a component used in a four-way handshake process for establishing a secure connection between a client device and an access point (AP). During the four-way handshake, which is a key exchange mechanism used for mutual authentication and generation of session keys, the dialog token is exchanged between the client and the AP. The dialog token serves as a unique identifier for each phase of the handshake, ensuring that both parties are synchronized and that the messages exchanged are part of the same transaction. This helps prevent replay attacks and ensures the integrity and freshness of the handshake process. The dialog token is included in the messages exchanged during the handshake to validate the sequence and integrity of the communication, thereby enhancing the security of the wireless connection.

In the context of wireless networking, particularly in technologies like 802.11ax (Wi-Fi 6) and beyond, a differential Compressed Beamforming Feedback (CBF) mode refers to a method of providing feedback on channel conditions and beamforming parameters from the receiver (client device) to the transmitter (access point). In this mode, instead of explicitly transmitting the full CBF information with each feedback frame, only the differences or differentials from the previous CBF frame are conveyed. This approach reduces the amount of data that needs to be transmitted, as typically only changes in the channel conditions or beamforming parameters are relevant for adaptive transmission strategies. By transmitting only differentials, the differential CBF feedback mode optimizes the use of network resources and reduces overhead, making it particularly suitable for scenarios with rapidly changing channel conditions or devices with limited bandwidth or processing capabilities.

In optimizing beamforming performance in wireless communication systems, several parameters play roles. These adjustments, often guided by channel feedback or adaptive algorithms, include tuning antenna weights to control beam directionality and mitigate interference. By adjusting the amplitude and phase of signals transmitted or received by each antenna element, beamforming can focus energy toward desired users or nullify interference from unwanted directions. Additionally, controlling the beam steering angle can be utilized for targeting specific communication links while minimizing interference. Beamwidth adjustment determines the coverage area of the transmitted signal, with narrower beams offering higher directional gain but requiring more precise alignment with receivers, while wider beams provide broader coverage. Leveraging accurate Channel State Information (CSI) obtained through channel sounding enables adaptive algorithms to optimize beamforming parameters in real-time or near real-time, considering factors like signal strength, interference, and noise levels. Efficient feedback mechanisms facilitate the exchange of channel condition information between transmitters and receivers, informing adaptive algorithms to make informed decisions. Moreover, accounting for environmental factors such as multipath propagation, reflection, diffraction, and obstacles may occur, with adaptive algorithms dynamically adjusting beamforming parameters to mitigate changing environmental conditions. By fine-tuning these parameters based on feedback and environmental considerations, beamforming techniques can optimize wireless communication performance, enhancing coverage, spectral efficiency, system capacity, and reliability.

Embodiments described herein disclose techniques to unify and optimize beamforming matrix feedback in multi-link operations (MLO) for reduced overhead and improved gain. The techniques of various embodiments synchronize sounding across links, unify matrices into one feedback instance on the strongest link, and leverage optimizations like differential feedback. The detailed unified feedback procedure for uplink sounding from station (device) to access point (AP) can be explained in certain embodiments below.

In a number of embodiments, the APs can coordinate to transmit uplink null data packets (NDPs) to the device on the involved links at nearly the same time with minimal skew. This simultaneously sounds the uplink channel on all links to minimize temporal decay between channel estimations. In more embodiments, on receiving the coordinated NDPs, the device performs uplink channel estimation on each link to compute a beamforming matrix for that link.

In additional embodiments, the device can aggregate the individual uplink matrices into a unified uplink MLO beamforming matrix using matrix concatenation, stacking, or other manipulation techniques. As a result, in some embodiments, the device can transmit a single compressed beamforming (CBF) feedback frame containing only the unified uplink matrix to the AP set over the link with highest SNR. This can eliminate sending redundant CBF frames on each link.

In further embodiments, a dialog token can bind the unified CBF sequence to the corresponding synchronized multi-link NDP sounding frames. In certain embodiments, if the individual uplink matrices show high correlation, the device can utilize a differential CBF feedback mode. A reference matrix for one link may be sent using CBF encoding. For other links, only the difference from the reference matrix may be signaled, further reducing overhead. In various embodiments, the APs can utilize the reconstructed full uplink matrices, representing the aggregate multi-link channel, for optimal coordinated spatial processing and transmit beamforming over the multiple links.

In some additional embodiments, similar unified procedures can be defined for downlink sounding from AP to device. In many embodiments, the APs can transmit tightly coordinated NDPs to the device across involved links for simultaneous downlink channel sounding, minimizing temporal decay between matrices. In response, certain embodiments may have the APs compute per-link downlink beamforming matrices based on the received NDPs from the device.

In more embodiments, the APs can aggregate the downlink matrices into a unified downlink MLO beamforming matrix using matrix manipulation techniques. In subsequent embodiments, one AP may send a single CBF frame with the unified downlink matrix over the optimal link to the device. The dialog token can identify the sequence as unified feedback for coordinated downlink sounding. As before, differential modes can be used if downlink matrices are partially correlated. In more further embodiments, the device can utilize the reconstructed full downlink matrices enabling optimal coordinated receive beamforming for the synchronized multi-link transmissions from the AP set.

In various embodiments, special considerations may be made for eMLSR deployments. For example, eMLSR may only have a single radio that can switch across several links. Therefore, it can't typically sound the channel in a parallel way, but the AP and eMLSR client can coordinate a staggered sounding across links and feedback the overall steering on a single link. Certain embodiments herein can define a new NDPA-ML which both announces the on-channel NDP but also specifies that the device will immediately tune to other bands to do sounding.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

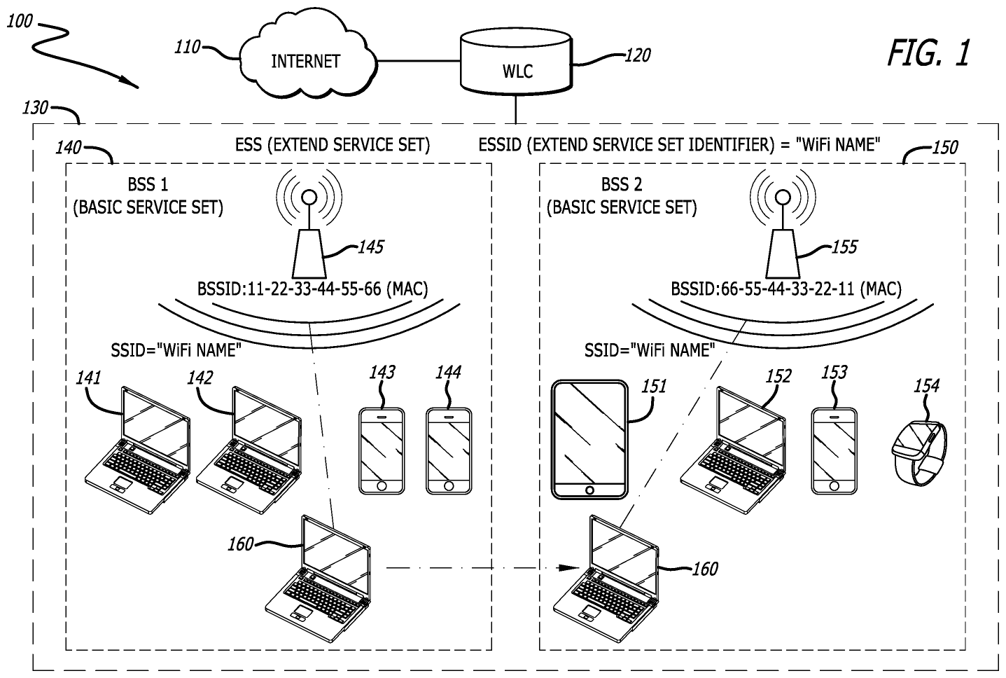

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a. 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

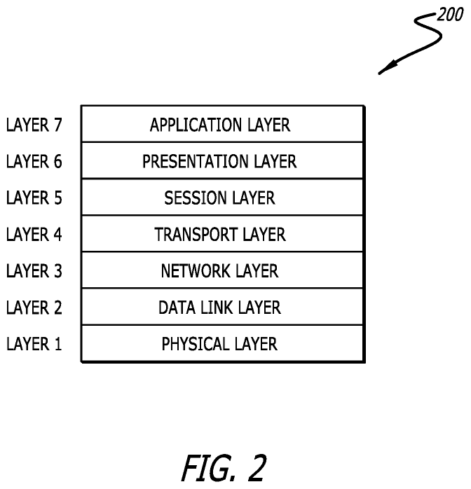

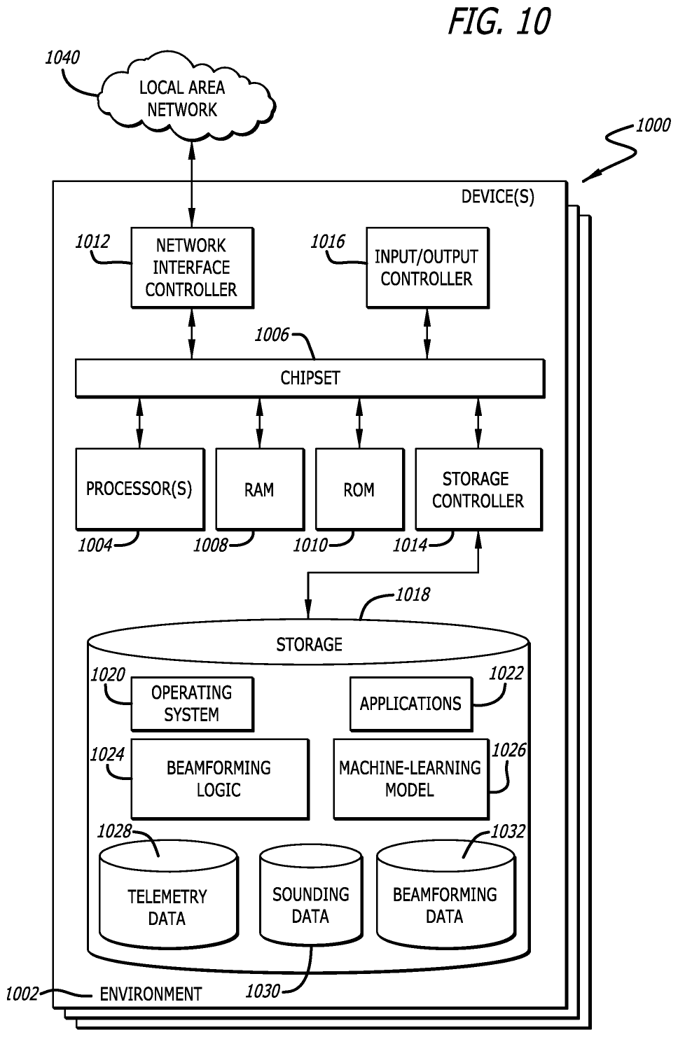

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 10, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-10 as required to realize a particularly desired embodiment.

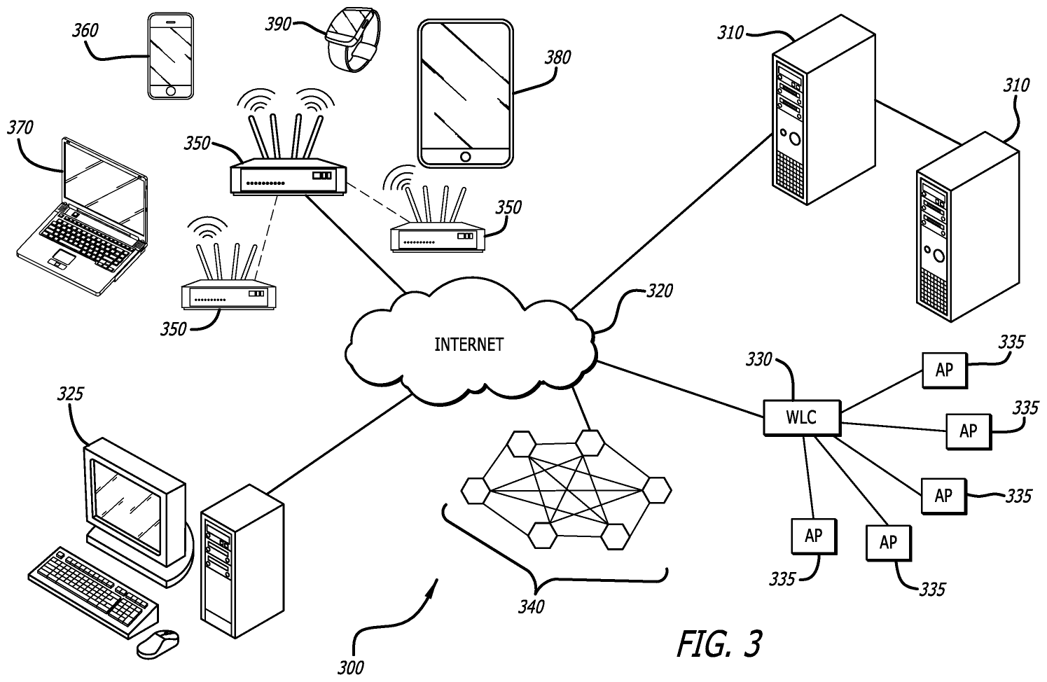

Referring to FIG. 3, a conceptual network diagram 300 of various environments that a networking logic may operate on a plurality of network devices, in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 310 can be configured with the networking logic or can otherwise operate as the networking logic. In many embodiments, the networking logic may operate on one or more servers 310 connected to a communication network 320 (shown as the “Internet”). The communication network 320 can include wired networks or wireless networks. The networking logic can be provided as a cloud-based service that can service remote networks, such as, but not limited to a deployed network 340.

However, in additional embodiments, the networking logic may be operated as a distributed logic across multiple network devices. In the embodiment depicted in FIG. 3, a plurality of network access points (APs) 350 can operate as the networking logic in a distributed manner or may have one specific device operate as the networking logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the networking logic may be integrated within another network device. In the embodiment depicted in FIG. 3, a wireless LAN controller (WLC) 330 may have an integrated networking logic that the WLC 330 can use to monitor or control power consumption of the APs 335 that the WLC 330 is connected to, either wired or wirelessly. In still more embodiments, a personal computer 325 may be utilized to access and/or manage various aspects of the networking logic, either remotely or within the network itself. In the embodiment depicted in FIG. 3, the personal computer 325 communicates over the communication network 320 and can access the networking logic of the servers 310, or the network APs 350, or the WLC 330.

Although a specific embodiment for various environments that the networking logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the networking logic may be provided as a device or software separate from the WLC 330 or the networking logic may be integrated into the WLC 330. The elements depicted in FIG. 3 may also be interchangeable with other elements of FIGS. 1-2 and FIGS. 4A-10 as required to realize a particularly desired embodiment.

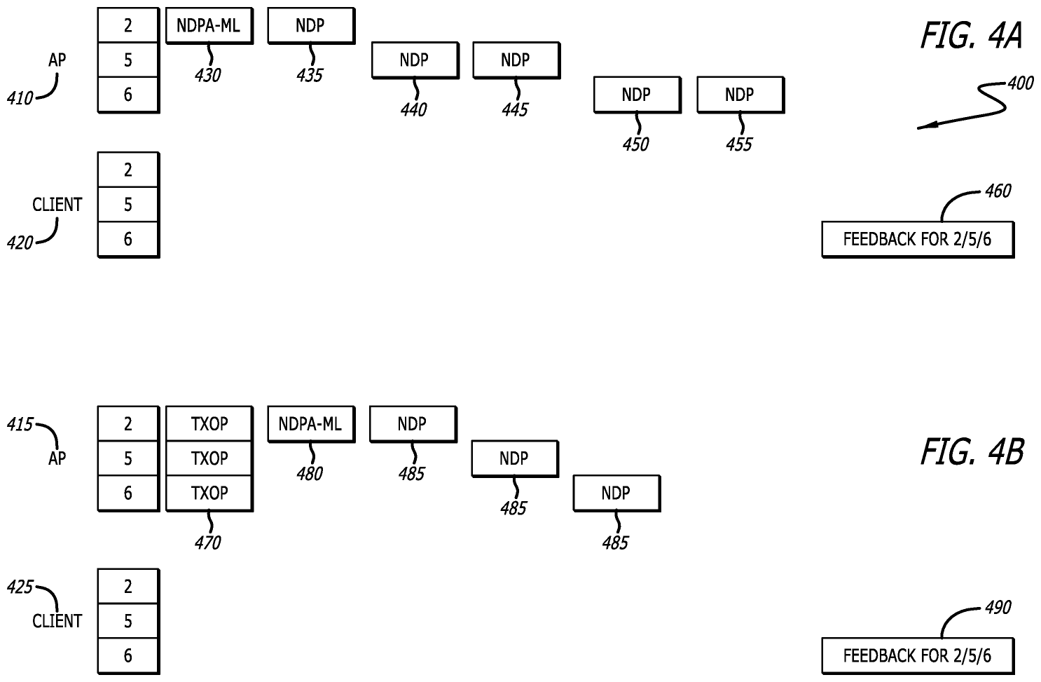

Referring to FIG. 4A, a conceptual illustration of a multi-radio, multi-band staggered sounding, in accordance with various embodiments of the disclosure is shown. The embodiment depicts an access point (AP) 410, and a client 420 that are engaging within a sounding/association process 400. The AP 410 and the client 420 each have a plurality of available links (shown as 2, 5, 6) that can be utilized. In the process depicted in FIG. 4A, the AP 410 can transmit a multi-link null data packet announcement 430 (shown as NDPA-ML). This multi-link null data packet announcement 430 is often configured to put a client 420 or other network device on notice that subsequent null data packets will be transmitted.

In the embodiment depicted in FIG. 4A, the multi-link null data packet announcement 430 is followed up by a first null data packet 435 on link 2. Subsequently, on link 5, a second null data packet 440 is transmitted followed by a third null data packet 445. Finally, a fourth null data packet 450 is transmitted on link 6 which is followed up by a fifth null data packet 455. In response to these transmissions, the client 420 can transmit feedback within a single feedback message 460 that combines feedback over links 2, 5 and 6. As described in more detail below, this can be related to a combined or unified beamforming matrix.

Although a specific embodiment for a multi-radio, multi-band staggered sounding suitable for carrying out the various steps, processes, methods, and operations described herein is discussed with respect to FIG. 4A, any of a variety of systems and/or processes may be utilized in accordance with embodiments of the disclosure. For example, the embodiment depicted in FIG. 4A can be utilized when transmission can occur simultaneously on multiple transceivers and/or bands. The elements depicted in FIG. 4A may also be interchangeable with other elements of FIGS. 1-3 and FIGS. 4B-10 as required to realize a particularly desired embodiment.

Referring to FIG. 4B, a conceptual illustration of a single-radio, multi-band staggered sounding, in accordance with various embodiments of the disclosure is shown. The embodiment depicts an access point (AP) 415, and a client 425 that are engaging within a sounding/association process. The AP 415 and the client 425 each have a plurality of available links (shown as 2, 5, 6) that can be utilized. In the process depicted in FIG. 4B, the AP 415 can transmit a plurality of transmissions opportunities 470, which can reserve upcoming transmission slots. This can, in certain embodiments, be configured as a control to self packet (a.k.a. a clear to send or “CTS2Self” packet). This self-CTS mechanism can help in avoiding collisions and ensuring that the device can safely transmit data without causing interference with its own transmissions. It's often utilized as a technique to manage the medium access in wireless communication, especially in scenarios where there might be hidden nodes or other complications that could lead to collisions.

This can be followed up by a multi-link null data packet announcement 480 is often configured to put a client 425 or other network device on notice that subsequent null data packets will be transmitted. In the embodiment depicted in FIG. 4B, the multi-link null data packet announcement 480 is followed up by a series of null data packets 485 on links 2, 5, and 6. In response to these transmissions, the client 425 can transmit feedback within a single feedback message 490 that combines feedback over links 2, 5 and 6. As described in more detail below, this can be related to a combined or unified beamforming matrix.

Although a specific embodiment for a single-radio, multi-band staggered sounding suitable for carrying out the various steps, processes, methods, and operations described herein is discussed with respect to FIG. 4B, any of a variety of systems and/or processes may be utilized in accordance with embodiments of the disclosure. For example, the embodiment depicted in FIG. 4A can be utilized when transmission can occur simultaneously on single transceivers and/or bands. The elements depicted in FIG. 4B may also be interchangeable with other elements of FIGS. 1-4A and FIGS. 5-10 as required to realize a particularly desired embodiment.

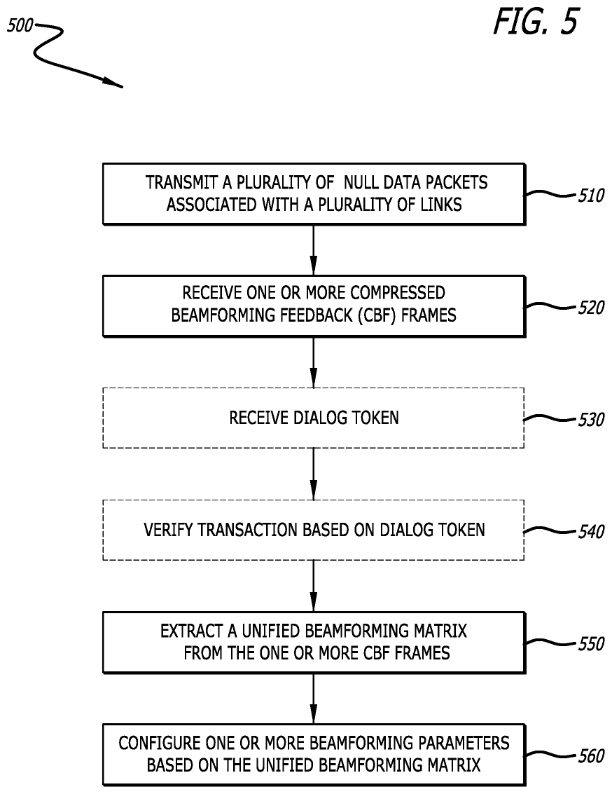

Referring to FIG. 5, a flowchart depicting a process 500 for configuring one or more downlink beamforming parameters based on a unified beamforming matrix in accordance with various embodiments of the disclosure is shown. In many embodiments, the process 500 can transmit a plurality of null data packets associated with a plurality of links (block 510). As discussed above, the null data packets (NDPs) can be a part of a sounding process. The NDPs can be transmitted on a plurality of different transceivers or links.

In a number of embodiments, the process 500 can receive one or more compressed beamforming feedback (CBF) frames (block 520). The CBF frames can be received from a single link or signal. However, as described below, the CBF frames can be associated with a plurality of different links.

In some optional embodiments, the process 500 can receive a dialog token (block 530). The dialog token can be configured for an exchange mechanism. As those skilled in the art will recognize, the dialog token can be utilized as part of a handshake to validate the sequence and improve the overall integrity of the communication.

In further optional embodiments, the process 500 can verify transaction based on the dialog token (block 540). The validation can be part of an established handshake process when exchanging data between a first and second device. However, the handshake may be between even more devices in certain embodiments.

In additional embodiments, the process 500 can extract a unified beamforming matrix from the one or more CBF frames (block 550). The unified beamforming matrix can be configured to include data related to multiple links. By transmitting the data within a single matrix, latency can be reduced, and overall data bandwidth may be preserved. Subsequently, the process 500 can parse the unified beamforming matrix.

In more embodiments, the process 500 can configure one or more downlink beamforming parameters based on the unified beamforming matrix (block 560). The downlink beamforming parameters can include any related to sounding and/or beamforming. As described above, beamforming parameters can be related to a plurality of items such as, but not limited to, signal strength, signal direction, signal timings, etc.

Although a specific embodiment for configuring one or more downlink beamforming parameters based on a unified beamforming matrix suitable for carrying out the various steps, processes, methods, and operations described herein is discussed with respect to FIG. 5, any of a variety of systems and/or processes may be utilized in accordance with embodiments of the disclosure. For example, the sounding process involving the exchange of NDPs and CBFs can vary based on the hardware available, such as those embodiments shown above with respect to FIGS. 4A and 4B. The elements depicted in FIG. 5 may also be interchangeable with other elements of FIGS. 1-4B and 6-10 as required to realize a particularly desired embodiment.

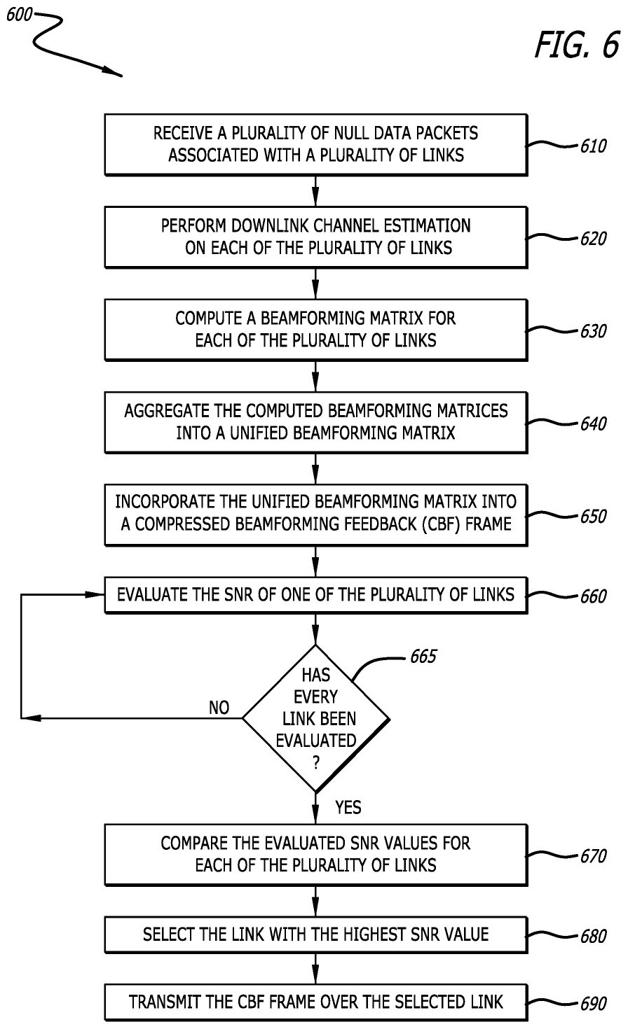

Referring to FIG. 6, a flowchart depicting a process 600 for generating a unified beamforming matrix for downlink connections in accordance with various embodiments of the disclosure is shown. In many embodiments, the process 600 can receive a plurality of null data packets associated with a plurality of links (block 610). In many embodiments, the null data packets can be configured to be part of a sounding process. For example, a client device can receive null data packets from an access point, and vice-versa.

In a number of embodiments, the process 600 can perform a downlink channel estimation on each of the plurality of links (block 620). As those skilled in the art will recognize, the specific characteristics of channel quality can vary from link to link. As such, various embodiments can analyze the available data, such as null data packets to determine and generate a downlink channel estimation or other related data for each of the plurality of links.

In more embodiments, the process 600 can compute a beamforming matrix for each of the plurality of links (block 630). As described above, the beamforming matrix can be generated based on the available data to form a construct that can direct other devices and/or adjust beamforming parameters to create a better signaling environment. In some embodiments, the computations are done simultaneously to avoid temporal decay, while certain embodiments may process the beamforming matrix sequentially based on available computational resources.

In further embodiments, the process 600 can aggregate the computed beamforming matrices into a unified beamforming matrix (block 640). In traditional embodiments, each of the beamforming matrices is transmitted back separately. However, embodiments described herein can aggregate or otherwise combine multiple beamforming matrices into a single unified beamforming matrix. The exact format of this unified beamforming matrix can vary depending on the application desired. Additionally, in numerous embodiments, the aggregation can occur over all of the available or determined links.

In additional embodiments, the process 600 can incorporate the unified beamforming matrix into a compressed beamforming feedback (CBF) frame (block 650). In certain embodiments, the beamforming feedback can avoid being compressed. However, various embodiments attempt to minimize the amount of data transmitted during the process 600.

In still more embodiments, the process 600 can evaluate the signal-to-noise ratio (SNR) values for each of the plurality of links (block 660). As those skilled in the art will recognize, there are various methods to determine and evaluate what a SNR value is for each link. The SNR values can be numerical or be classified within one or more groupings.

In certain embodiments, the process 600 can determine if every link has been evaluated (block 665). As stated above, there may be a plurality of links associated with a connection. However, each of these connections can be evaluated. If it is determined that every link has not been evaluated, the process 600 can again evaluate the SNR values for the plurality of links (block 660). However, if it is determined that all of the links have been evaluated, then the process 600 can compare the evaluated SNR values for each of the plurality of links (block 670).

In various embodiments, the process 600 can select the link with the highest SNR value (block 680). This selection can simply be based on a value that is either lowest or highest based on the type of evaluation being done. The SNR values may also be categorized such that certain values beyond a threshold value are considered for selection and any link within a certain threshold may be selected.

In yet further embodiments, the process 600 can transmit the CBF frame over the selected link (block 690). The CBF frame can be transmitted over the link but can be transmitted, in certain embodiments, over multiple links depending on the application desired. The transmission can be direct to a network device, but may be broadcast out for the corresponding device to receive and process.

Although a specific embodiment for generating a unified beamforming matrix for downlink connections suitable for carrying out the various steps, processes, methods, and operations described herein is discussed with respect to FIG. 6, any of a variety of systems and/or processes may be utilized in accordance with embodiments of the disclosure. For example, the process 600 can occur upon first connection, but may occur or re-occur at a predetermined interval or in response to an event. The elements depicted in FIG. 6 may also be interchangeable with other elements of FIGS. 1-5 and 7-10 as required to realize a particularly desired embodiment.

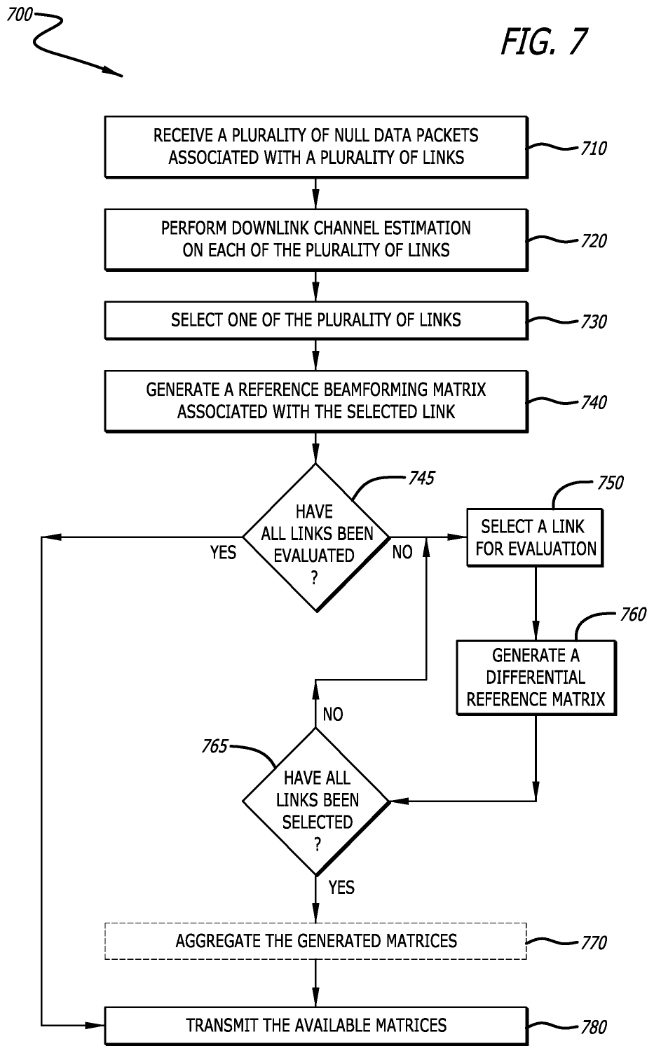

Referring to FIG. 7, a flowchart depicting a process 700 for establishing a connection via a differential feedback mode in accordance with various embodiments of the disclosure is shown. In many embodiments, the process 700 can receive a plurality of null data packets associated with a plurality of links (block 710). The null data packets can be associated with a connection or other association process.

In a number of embodiments, the process 700 can perform downlink channel estimation on each of the plurality of links (block 720). As those skilled in the art will recognize, the specific characteristics of channel quality can vary from link to link. As such, various embodiments can analyze the available data, such as null data packets to determine and generate a downlink channel estimation or other related data for each of the plurality of links.

In more embodiments, the process 700 can select one of the plurality of links (block 730). The selection can be random, or be based upon one or more criteria. For example, the selection may be the strongest link, the first link received, and/or the first link processed.

In further embodiments, the process 700 can generate a reference beamforming matrix associated with the selected link (block 740). As described above, the beamforming matrix can be generated based on the available data to form a construct that can direct other devices and/or adjust beamforming parameters to create a better signaling environment. In some embodiments, the computations are done simultaneously to avoid temporal decay, while certain embodiments may process the beamforming matrix sequentially based on available computational resources.

In certain embodiments, the process 700 can determine if all of the links have been evaluated (block 745). As stated above, there may be a plurality of links associated with a connection. However, each of these connections can be evaluated. If all links have been evaluated, the process 700 can transmit the available matrices (block 780). However, if it has been determined that all of the links have been evaluated, then the process 700 can select a link for evaluation (block 750).

In additional embodiments, the process 700 can generate a differential reference matrix (block 760). The differential reference matrix can be a matrix the is comprised of data that marks or otherwise notes a deviation from the original and/or previously generated reference beamforming matrices. This can be formatted to reduce the amount of data necessary to create the necessary matrices.

In various embodiments, the process 700 can determine if all of the links have been selected (block 765). If it has been determined that all of the links have not been selected, then the process 700 can again select a link for evaluation (block 750). However, if it is determined that all links have been selected, then the process 700 can, in optional embodiments, aggregate the generated matrices (block 770). The aggregation can be combining the existing matrices in a concatenation form. However, other combination methods can be utilized depending on the application desired. In certain embodiments, aggregation may not be required.

In still more embodiments, the process 700 can transmit the available matrices (block 780). In some embodiments, the transmission can include the aggregated matrices. In certain embodiments however, the transmission can include non-aggregated matrices. The transmission can be direct to a network device, but may be broadcast out for the corresponding device to receive and process.

Although a specific embodiment for establishing a connection via a differential feedback mode suitable for carrying out the various steps, processes, methods, and operations described herein is discussed with respect to FIG. 7, any of a variety of systems and/or processes may be utilized in accordance with embodiments of the disclosure. For example, the process 700 can be utilized for uplink transmission connections as well as downlink connections. The elements depicted in FIG. 7 may also be interchangeable with other elements of FIGS. 1-6 and 8-10 as required to realize a particularly desired embodiment.

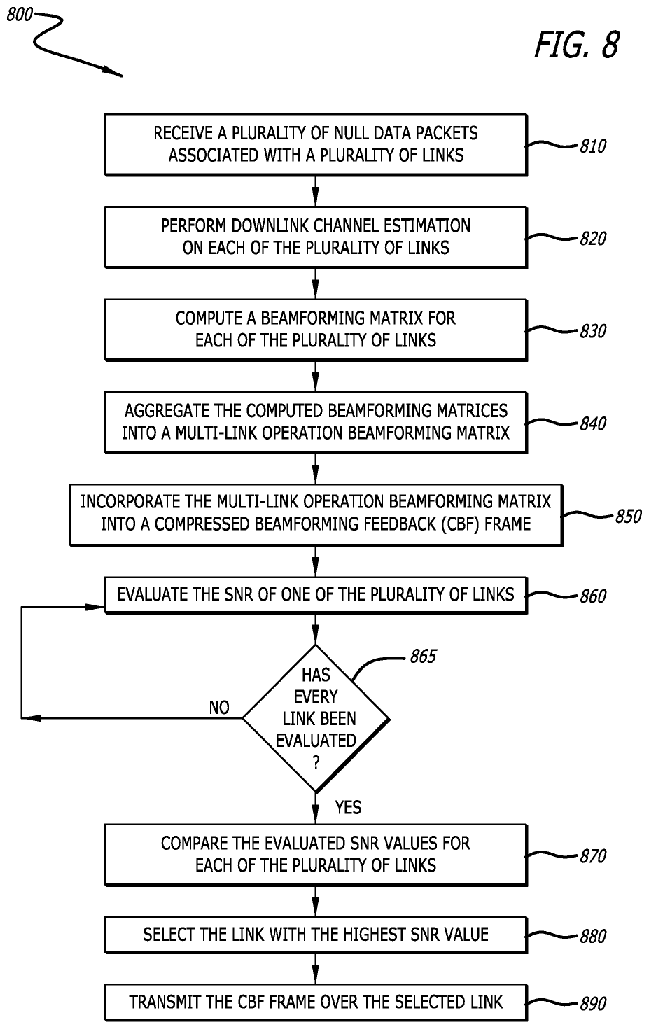

Referring to FIG. 8, a flowchart depicting a process 800 for generating a unified beamforming matrix for uplink connections in accordance with various embodiments of the disclosure is shown. In many embodiments, the process 800 can receive a plurality of null data packets associated with a plurality of links (block 810). In many embodiments, the null data packets can be configured to be part of a sounding process. For example, a client device can receive null data packets from an access point, and vice-versa.

In a number of embodiments, the process 800 can perform an uplink channel estimation on each of the plurality of links (block 820). As those skilled in the art will recognize, the specific characteristics of channel quality can vary from link to link. As such, various embodiments can analyze the available data, such as null data packets to determine and generate an uplink channel estimation or other related data for each of the plurality of links.

In more embodiments, the process 800 can compute a beamforming matrix for each of the plurality of links (block 830). As described above, the beamforming matrix can be generated based on the available data to form a construct that can direct other devices and/or adjust beamforming parameters to create a better signaling environment. In some embodiments, the computations are done simultaneously to avoid temporal decay, while certain embodiments may process the beamforming matrix sequentially based on available computational resources.

In further embodiments, the process 800 can aggregate the computed beamforming matrices into a multi-link operation (MLO) beamforming matrix (block 840). In traditional embodiments, each of the beamforming matrices is transmitted back separately. However, embodiments described herein can aggregate or otherwise combine multiple beamforming matrices into an MLO beamforming matrix. The exact format of this unified beamforming matrix can vary depending on the application desired. Additionally, in numerous embodiments, the aggregation can occur over all of the available or determined links.

In additional embodiments, the process 800 can incorporate the MLO beamforming matrix into a compressed beamforming feedback (CBF) frame (block 850). In certain embodiments, the beamforming feedback can avoid being compressed. However, various embodiments attempt to minimize the amount of data transmitted during the process 800.

In still more embodiments, the process 800 can evaluate the signal-to-noise ratio (SNR) values for each of the plurality of links (block 860). As those skilled in the art will recognize, there are various methods to determine and evaluate what a SNR value is for each link. The SNR values can be numerical or be classified within one or more groupings.

In certain embodiments, the process 800 can determine if every link has been evaluated (block 865). As stated above, there may be a plurality of links associated with a connection. However, each of these connections can be evaluated. If it is determined that every link has not been evaluated, the process 800 can again evaluate the SNR values for the plurality of links (block 860). However, if it is determined that all of the links have been evaluated, then the process 800 can compare the evaluated SNR values for each of the plurality of links (block 870).

In various embodiments, the process 800 can select the link with the highest SNR value (block 880). This selection can simply be based on a value that is either lowest or highest based on the type of evaluation being done. The SNR values may also be categorized such that certain values beyond a threshold value are considered for selection and any link within a certain threshold may be selected.

In yet further embodiments, the process 800 can transmit the CBF frame over the selected link (block 890). The CBF frame can be transmitted over the link but can be transmitted, in certain embodiments, over multiple links depending on the application desired. The transmission can be direct to a network device, but may be broadcast out for the corresponding device to receive and process.

Although a specific embodiment for generating a unified beamforming matrix for uplink connections suitable for carrying out the various steps, processes, methods, and operations described herein is discussed with respect to FIG. 8, any of a variety of systems and/or processes may be utilized in accordance with embodiments of the disclosure. For example, the uplink process can be utilized to generate an aggregated MLO beamforming matrix or just a unified beamforming matrix. The elements depicted in FIG. 8 may also be interchangeable with other elements of FIGS. 1-7 and 9-10 as required to realize a particularly desired embodiment.

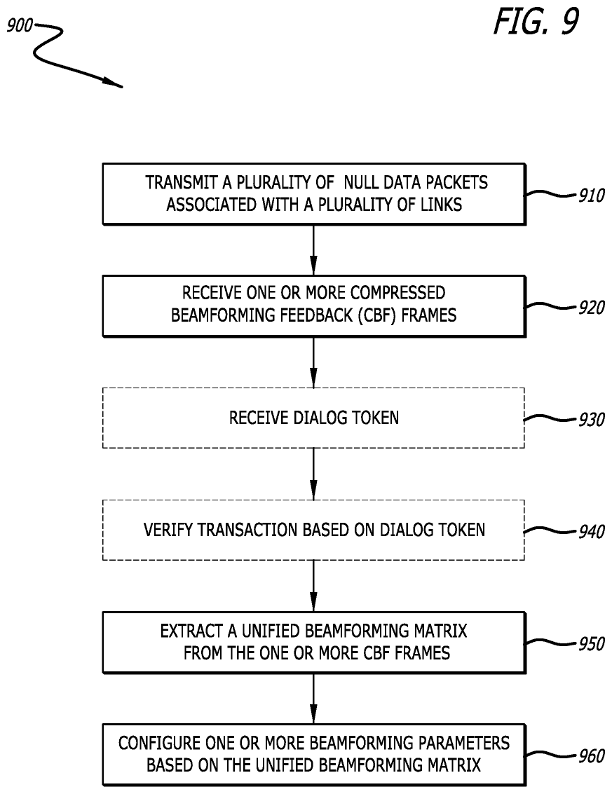

Referring to FIG. 9, a flowchart depicting a process 900 for configuring one or more uplink beamforming parameters based on a unified beamforming matrix in accordance with various embodiments of the disclosure is shown. In many embodiments, the process 900 can transmit a plurality of null data packets associated with a plurality of links (block 910). As discussed above, the null data packets (NDPs) can be a part of a sounding process. The NDPs can be transmitted on a plurality of different transceivers or links.

In a number of embodiments, the process 900 can receive one or more compressed beamforming feedback (CBF) frames (block 920). The CBF frames can be received from a single link or signal. However, as described below, the CBF frames can be associated with a plurality of different links.

In some optional embodiments, the process 900 can receive a dialog token (block 930). The dialog token can be configured for an exchange mechanism. As those skilled in the art will recognize, the dialog token can be utilized as part of a handshake to validate the sequence and improve the overall integrity of the communication.

In further optional embodiments, the process 900 can verify transaction based on the dialog token (block 940). The validation can be part of an established handshake process when exchanging data between a first and second device. However, the handshake may be between even more devices in certain embodiments.

In additional embodiments, the process 900 can extract a unified beamforming matrix from the one or more CBF frames (block 950). The unified beamforming matrix can be configured to include data related to multiple links. By transmitting the data within a single matrix, latency can be reduced, and overall data bandwidth may be preserved.

In more embodiments, the process 900 can configure one or more uplink beamforming parameters based on the unified beamforming matrix (block 960). The uplink beamforming parameters can include any related to sounding and/or beamforming. As described above, beamforming parameters can be related to a plurality of items such as, but not limited to, signal strength, signal direction, signal timings, etc.

Although a specific embodiment for configuring one or more uplink beamforming parameters based on a unified beamforming matrix suitable for carrying out the various steps, processes, methods, and operations described herein is discussed with respect to FIG. 9, any of a variety of systems and/or processes may be utilized in accordance with embodiments of the disclosure. For example, the sounding process involving the exchange of NDPs and CBFs can vary based on the hardware available, such as those embodiments shown above with respect to FIGS. 4A and 4B. The elements depicted in FIG. 9 may also be interchangeable with other elements of FIGS. 1-8 and 10 as required to realize a particularly desired embodiment.

Referring to FIG. 10, a conceptual block diagram of a device suitable for configuration with a beamforming logic 1024 in accordance with various embodiments of the disclosure is shown. The embodiment of the conceptual block diagram depicted in FIG. 10 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In many further embodiments, the device 1000 may include a networking logic 1024. The networking logic 1024 can be configured to perform one or more of the various steps, processes, operations, and/or other methods that are described above. Often, the networking logic 1024 can be a set of instructions stored within a non-volatile memory that, when executed by the controller(s)/processor(s) 1004 can carry out these steps, etc. In some embodiments, the networking logic 1024 may be a client application that resides on a network-connected device, such as, but not limited to, a server, switch, personal or mobile computing device in a single or distributed arrangement.

In some embodiments, telemetry data 1028 can encompass real-time measurements crucial for monitoring and optimizing network performance. It may include details like bandwidth usage, latency, packet loss, and error rates, providing insights into data transmission quality and identifying potential issues. Telemetry data 1028 may also cover traffic patterns and application performance, supporting capacity planning and ensuring optimal user experience. The collection and analysis of this data are essential for proactive network management, facilitated by advanced monitoring tools and technologies.

In various embodiments, sounding data 1030 can comprise information gathered during the process of probing or scanning for available networks, often conducted by devices seeking to establish connections. This data might include details such as signal strength, network identifiers (such as SSIDs), channel utilization, supported data rates, encryption methods, and sometimes even device capabilities like supported protocols, multi-link operations, and/or antenna configurations. Sounding data 1030 can aid in determining the quality and availability of wireless connections, helping devices make informed decisions about which network to join and how to optimize their connection parameters for improved performance. In certain systems, such as, but not limited to, MIMO and MU-MIMO systems, where multiple antennas are used for transmission and reception, sounding data 1030 can help in assessing the channel state information at both ends of the communication link. By probing the wireless channel, devices can estimate the quality of the connection, identify multipath propagation effects, and determine the spatial characteristics of the channel. This knowledge is then used to construct beamforming matrices that maximize signal strength, minimize interference, and improve overall communication performance.

In a number of embodiments, beamforming data 1032 may comprise a variety of information for steering and optimizing wireless signals in beamforming systems. At its core may lie Channel State Information (CSI), which can provide insight into the characteristics of the wireless channel between the transmitter and receiver antennas. This may include metrics such as channel gains, phase shifts, and signal-to-noise ratios (SNR), all of which can be utilized for determining the optimal beamforming weights or coefficients to maximize signal strength while minimizing interference. Additionally, beamforming data 1032 may include details about the spatial channel characteristics, such as angles of arrival and departure of signals, multipath propagation effects, and spatial correlations. Understanding these properties may be useful in forming directional beams towards intended recipients and mitigating the impact of signal reflections and fading.

Moreover, beamforming data 1032 can encompass information about the configuration of the antenna array being used. Beamforming systems often employ arrays of multiple antennas for transmission and reception, and details about the physical arrangement of these antennas, such as their positions, orientations, and polarization. This can be useful for accurately steering and shaping the radiation patterns of transmitted signals. Additionally, beamforming parameters such as beamforming weights, matrices, and vectors can also be utilized. These parameters may determine how signals are combined and phased across the antenna array to achieve desired spatial characteristics and signal coverage, making them useful in the beamforming process. Lastly, in some beamforming systems, feedback and control information are exchanged between devices to adaptively adjust beamforming parameters based on changing channel conditions. This feedback loop may include acknowledgments, channel quality indicators, and requests for retransmissions, enabling dynamic optimization of beamforming strategies in real-time.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the telemetry data 1028, the power sounding data 1030, and the beamforming data 1032. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a beamforming suitable for carrying out the various steps, processes, methods, and operations described herein is discussed with respect to FIG. 10, any of a variety of systems and/or processes may be utilized in accordance with embodiments of the disclosure. For example, X. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a beamforming logic that is configured to:
receive a null data packet (NDP), wherein the NDP is associated with two or more links;
perform a downlink channel estimation on each of the two or more links;
compute a beamforming matrix for each of the two or more links; and
aggregate each beamforming matrix into a unified beamforming matrix.

2. The device of claim 1, wherein the beamforming logic is further configured to incorporate the unified beamforming matrix into a compressed beamforming feedback (CBF) frame.

3. The device of claim 2, wherein the beamforming logic is further configured to evaluate a signal-to-noise ratio (SNR) value for each of the two or more links.

4. The device of claim 3, wherein the beamforming logic is further configured to select a link with a highest SNR value.

5. The device of claim 4, wherein the beamforming logic is further configured to transmit the CBF frame over the selected link.

6. The device of claim 5, wherein the beamforming logic is further configured to transmit a dialog token associated with the unified beamforming matrix.

7. The device of claim 1, wherein the null data packet is associated with a multi-link beamforming process.

8. The device of claim 1, wherein the aggregation of each beamforming matrix is based on a matrix concatenation process.

9. The device of claim 1, wherein the aggregation of each beamforming matrix is based on a stacking process.

10. The device of claim 2, wherein the aggregation of each beamforming matrix is based on a differential CBF feedback mode.

11. A device, comprising:
a processor;
at least one network interface controller configured to provide access to a network; and
a memory communicatively coupled to the processor, wherein the memory comprises a beamforming logic that is configured to:
transmit at least one null data packet;
receive one or more compressed beamforming feedback (CBF) frames;
extract a unified beamforming matrix from the one or more CBF frames;
parse the unified beamforming matrix; and
adjust one or more beamforming parameters based on the unified beamforming matrix.

12. The device of claim 11, wherein the beamforming logic is further configured to receive a dialog token associated with the one or more CBF frames.

13. The device of claim 12, wherein the beamforming logic is further configured to verify the received one or more CBF frames based on the received dialog token.

14. The device of claim 11, wherein the beamforming logic instead extracts a reference beamforming matrix and at least one differential reference matrix.

15. The device of claim 14, wherein the adjustment of the one or more beamforming parameters are based on the reference beamforming matrix and the at least one differential reference matrix.

16. A method of managing a network, comprising:
receiving a null data packet (NDP), wherein the NDP is associated with two or more links;
performing a downlink channel estimation on each of the two or more links;
compute a reference beamforming matrix for a first link of the two or more links; and
generate a differential reference matrix for each remaining link of the two or more links.

17. The method of claim 16, wherein the method further includes transmitting the reference beamforming matrix followed by the differential reference matrix.

18. The method of claim 17, wherein the method further includes transmitting each differential reference matrix.

19. The method of claim 18, wherein the reference beamforming matrix and each reference matrix is incorporated into a compressed beamforming feedback (CBF) frame.

20. The method of claim 19, wherein the transmitting of the reference beamforming matrix and each differential reference matrix is based on transmitting the CBF frame.
